(19) United States
(12) Patent Application Publication
(10) Pub. No.: US 2010/0214233 A1
(43) Pub. Date: Aug. 26, 2010

(54) TOUCH PANEL HAVING CLOSED LOOP ELECTRODE FOR EQUIPOTENTIAL BUILD-UP AND MANUFACTURING METHOD THEREOF

(75) Inventor: Min A. Lee, Seoul (KR)

Correspondence Address: KANG INTELLECTUAL PROPERTY LAW, LLC, 214 ELM STREET, SUITE 106, WASHINGTON, MO, 63090, US

(73) Assignee: AMPNT, INC., Gunpo-si (KR)

(21) Appl. No.: 12/449,334

(22) PCT Filed: Jan. 28, 2008
(86) PCT No.: PCT/KR2008/000515

§ 371 Date: Mar. 11, 2010

(30) Foreign Application Priority Data
Feb. 2, 2007 (KR) 10-2007-0010982
Jan. 25, 2008 (KR) 10-2008-0007972

(51) Int. Cl. G06F 3/041; B41J 2/01

(52) U.S. Cl. 345/173; 347/1

(57) ABSTRACT

A touch panel for a 5-line touch screen or a capacitive touch screen, and a manufacturing method thereof are provided. More particularly, a touch panel in which an equipotential forming electrode may be formed in a simple closed-loop pattern in order to reduce a screen dead zone and expand an active region by eliminating the linearity distortion of equipotential lines in around the equipotential forming electrode of the touch panel, and also may be applicable to a touch screen of a small device such as a mobile phone, and may reduce a process error rate and improve a productivity and electrical requirements such as terminal resistance and the like, and a manufacturing method thereof are provided. The equipotential forming electrode may be patterned using a much more conductive material than a material of a transparent conductive film. The equipotential forming electrode may form a closed loop in a linear pattern, a square-zigzagged pattern, a triangular saw pattern, or a wave pattern. The thickness, the width, and the electrical conductivity of the pattern may be adjusted so that resistance between signal connection terminals may be greater than some ohms. An auxiliary electrode may be further provided to improve the potential characteristic of the electrode formed in the closed loop.

### TECHNICAL FIELD

The present invention relates to a touch panel that is used for a touch screen of an electronic display device in charge of information input and a manufacturing method thereof. More particularly, the present invention relates to a touch panel in which an equipotential forming electrode may be formed in a simple closed-loop pattern in order to reduce a screen dead zone and expand an active region by eliminating the linearity distortion of equipotential lines in around the equipotential forming electrode of the touch panel, and also may be applicable to a touch screen of a small device such as a mobile phone, and may reduce a process error rate and improve a productivity and electrical requirements such as terminal resistance and the like, and a manufacturing method thereof.

### BACKGROUND ART

A touch screen uses a resistive type, a capacitive type, an ultrasonic type, an infrared ray type, and the like. Generally, a dual resistive type of 4-line touch screen and a capacitive touch screen are being used. The 4-line is widely used to the touch screen from a small size to a medium-and-large size greater than 20 inches. Due to the size of electrodes and an effective region, the capacitive type is generally applied for the medium-and-large size from 10 inches to 20 inches. The resistive type of 5-line touch screen may significantly improve the reliability in comparison to the 4-line touch screen, whereas a pattern of an equipotential forming electrode is patterned similar to electrodes of the capacitive touch screen. Therefore, the resistive type of 5-line touch screen is also generally applied for the medium-and-large size.

FIG. 1 is a perspective view for describing the structure of a capacitive touch panel 10 according to a conventional art.

Referring to FIG. 1, in the capacitive touch panel 10 according to the conventional art, transparent conductive films 12 and 13 is formed on and beneath a transparent substrate 11. The transparent substrate 11 is made of glass and the like. The transparent conductive films 12 and 13 are made of transparent conductive oxide (TCO) material such as indium tin oxide (ITO), zinc oxide (ZnO), stannic oxide (SnO2), and the like. An equipotential forming electrode 14 is formed on the upper transparent conductive film 12. A protective layer 15 contacting with a finger of a human being is formed on the equipotential forming electrode 14. When the finger contacts on the protective layer 15 of the touch panel 10 that includes the above layers, capacitive coupling is formed between the finger and the protective layer 15. In this instance, the change in signals transferred to the upper transparent conductive film 12 is read via the transparent conductive film 12 and the like to thereby interpret coordinates (x, y) of a contacting location of the finger. The equipotential forming electrode 14 may uniformly distribute equipotential on the upper transparent conductive film 12 and thereby enable the contacting location of the finger to be accurately interpreted.

FIG. 2 is a perspective view for describing the structure of a 5-line touch panel 20 of a resistive type according to the conventional art.

Referring to FIG. 2, in the 5-line touch panel 20 according to the conventional art, a transparent conductive film 22 is formed on a lower transparent substrate 21 made of a glass and the like. An equipotential forming electrode 23 is formed on the transparent conductive film 22. The lower transparent substrate 21 is closely attached to an upper transparent substrate 26 with maintaining a predetermined interval with the upper transparent substrate 26 via a spacer 24. The upper transparent substrate 26 may be made of a glass or a transparent film. A transparent conductive film 25 is formed below the upper transparent substrate 26. In the touch panel 20 that includes the above layers, when a finger, a pen, and the like contacts on the upper transparent substrate 26, the transparent conductive film 25 disposed below the upper transparent substrate 26 may contact with the transparent conductive film 22 disposed on the lower transparent conductive film 21 at the contacting location of the finger. In this instance, coordinates (x, y) of the contacting location of the finger may be interpreted by reading the change in signals transferred to the transparent conductive film 22 disposed on the lower transparent substrate 21 via the transparent conductive film 25. Here, the equipotential forming electrode 23 may uniformly distribute equipotential on the transparent conductive film 22 disposed on the lower transparent substrate 21 and thereby enable the contacting location of the finger to be accurately interpreted.

FIG. 3 is a top view illustrating an example of a pattern of an equipotential forming electrode according to the conventional art. As shown in FIG. 3, the equipotential forming electrode includes horizontal patterns 31 and vertical patterns 32 along an edge of a transparent conductive film disposed on a TCO substrate. Necessary signals are applied via signal connection terminals A, B, C, and D that are disposed in corners, respectively. The horizontal patterns 31 are symmetrically formed with respect to the edge of upper and lower sides of the TCO substrate. The vertical patterns 32 are also symmetrically formed with respect to the edge of left and right sides of the TCO substrate. For the equipotential forming, the horizontal patterns 31 and the vertical patterns 32 may be patterned into the same shape of metal electrodes, for example, fired silver paste. Also, the horizontal patterns 31 and the vertical patterns 32 may be patterned into a different shape of metal electrodes.

FIG. 4 is a top view for describing a relation between an active region and the equipotential formed in FIG. 3.

Referring to FIG. 4, when the equipotential forming electrode is patterned as shown in FIG. 3, the significant equipotential distortion can be seen in around metal electrode of the edge. Accordingly, there is a need for a distance between an active region ensuring the linearity and a viewing region exposed for display. Specifically, since the active region starts from a location that is spaced apart from the equipotential forming electrode by a predetermined distance, a dead zone occurs. Due to the dead zone, a marginal ratio of an active display region to the total viewing region increases in a small device such as a mobile phone. In this aspect, it may be difficult to apply the touch panel to the small device.

Also, when disconnected metal electrodes as shown in FIG. 3 are patterned in a plurality of layers as the equipotential forming electrode, the total viewing region and the active display region may be reduced on the TCO substrate. Accordingly, it is difficult to apply the touch panel to the small device such as a mobile phone needing a possible minimum size.

In order to distribute equipotential ensuring the linearity to the edge of the equipotential forming electrode, electrodes for the equipotential forming should be precisely printed in the symmetric structure as shown in FIG. 3. However, in a relatively inexpensive printing process to pattern metal electrodes, the precise printing for reducing an error rate may not be easy.

### DISCLOSURE OF INVENTION

### Technical Goals

In order to solve the above-described problems, an aspect of the present invention provides a touch panel in which an equipotential forming electrode may be formed in a seamless continuously-connected closed loop to eliminate the linearity distortion of equipotential lines in around the equipotential forming electrode and thereby may reduce a dead zone and maximize an active region, when forming the equipotential forming electrode on a transparent conductive substrate, for example, a substrate that is coated with a transparent conductive oxide (TCO) thin film of indium tin oxide (ITO), al doped zinc oxide (AZO), antimony tin oxide (ATO), and the like, a substrate that is coated with a half-mirror thin film of aluminum (Al), nickel (Ni), chromium (Cr), stainless steel (SUS), tin (Ti), and the like, or a substrate that is coated with other conductive transparent film, and a manufacturing method thereof.

Another aspect of the present invention also provides a touch panel in which an equipotential forming electrode may be patterned in as a simple pattern as possible and thereby may reduce an error rate in a patterning process and improve the productivity, and a manufacturing method thereof.

Another aspect of the present invention also provides various types of touch panels in which an equipotential forming electrode may be formed on a transparent conductive substrate in various types, based on a shape, an electrical conductivity (terminal resistance), a size (line width), and the like, and thereby may be applicable to a touch screen of a small device such as a mobile phone, and a manufacturing method thereof.

When applying the above closed-loop electrode to a small device, wiring may be formed to reduce the electrical conductivity of the closed-loop electrode wiring in order to increase resistance between signal connection terminals and thereby reduce the power consumption. In this case, equipotential lines may be bent to deteriorate the linearity. In order to solve this problem, another aspect of the present invention also provides a touch panel that may improve the linearity of equipotential lines by adjusting a material of closed-loop electrode wiring, a line width thereof, a thickness thereof, or a number of patterns for each unit length, or by inserting an auxiliary electrode to the closed-loop electrode, or by separating the auxiliary electrode from a signal connection terminal.

### Technical Solutions

In order to achieve the above objectives of the present invention, according to an aspect of the present invention, there is provided a touch panel for a touch screen, including: a transparent conductive film and an equipotential forming electrode on a transparent substrate, wherein the equipotential forming electrode is formed before or after the transparent conductive film is coated on the transparent substrate, and the equipotential forming electrode comprises a closed-loop electrode that is formed to overlap the transparent conductive film along an edge of an equipotential forming region of the transparent substrate.

A material of the closed-loop electrode may have an electrical conductivity greater than a material of the transparent conductive film. The material of the closed-loop electrode may include at least one of indium tin oxide (ITO), al doped zinc oxide (AZO), antimony tin oxide (ATO), aluminum (Al), nickel (Ni), chromium (Cr), stainless steel (SUS), tin (Ti), and silver (Ag).

The closed-loop electrode may include: a plurality of signal connection terminals being connected to a pattern of the closed-loop electrode using the same material, or being separated from the pattern of the closed-loop electrode. The resistance of the closed-loop electrode between the signal connection terminals may be less than or equal to 10 kilo ohms. Also, the closed-loop electrode may be patterned into at least one of a linear pattern, a square-zigzagged pattern, a triangular saw pattern, and a wave pattern, between the signal connection terminals.

According to another aspect of the present invention, there is provided a touch panel including: a transparent conductive film and an equipotential forming electrode on a transparent substrate, wherein the equipotential forming electrode is formed before or after the transparent conductive film is coated on the transparent substrate, and the equipotential forming electrode comprises a closed-loop electrode that is formed to overlap the transparent conductive film along an edge of an equipotential forming region of the transparent substrate, and the closed-loop electrode is formed in a pattern with a constant width from the edge of the transparent substrate by forming a predetermined conductive thin film on the entire surface of the transparent substrate and eliminating a region excluding a portion corresponding to the closed-loop electrode.

According to still another aspect of the present invention, there is provided a touch panel including: an equipotential forming electrode on a transparent substrate, wherein the equipotential forming electrode is formed in a closed-loop electrode along an edge of an equipotential forming region of the transparent substrate and comprises a plurality of signal connection terminals, and the closed-loop electrode is formed by forming a predetermined conductive thin film on the entire surface of the transparent substrate and then eliminating a plurality of patterns in a predetermined shape in an inner region of the transparent substrate that is spaced apart from the edge by a predetermined distance.

According to yet another aspect of the present invention, there is provided a touch panel including: a transparent substrate; a transparent conductive film being coated on a predetermined layer disposed on the transparent substrate; and an equipotential forming electrode being formed before or after the transparent conductive film is coated on the transparent substrate, to overlap the transparent electrode film along an edge of an equipotential forming region of the transparent substrate, wherein the equipotential forming electrode includes: four signal connection terminals being located in corners, respectively; horizontal patterns being formed in two horizontal sides, respectively, between the respective two signal connection terminals; and vertical patterns being formed in two vertical sides, respectively, between the respective two signal connection terminals, wherein the equipotential forming electrode is formed in a single closed-loop and when predetermined signals are applied to the signal connection terminals, an equipotential is formed between the facing horizontal patterns or between the facing vertical patterns.

The touch panel may be used for a 5-line resistive touch screen or a capacitive touch screen.

According to a further another aspect of the present invention, there is provided a method of manufacturing a touch panel for a touch screen, including: coating a transparent conductive film on a transparent substrate; and forming a closed-loop electrode for forming an equipotential before or after the transparent conductive film is coated on the transparent substrate, wherein the closed-loop electrode is formed to overlap the transparent conductive film along an edge of an equipotential forming region of the transparent substrate.

According to still another aspect of the present invention, there is provided a touch panel for a touch screen, including: a transparent conductive film and an equipotential forming electrode on a transparent substrate, wherein the equipotential forming electrode comprises a closed-loop electrode in which a resistance value for each unit length changes with respect to the horizontal direction or the vertical direction between a plurality of signal connection terminals.

The closed-loop electrode may be formed before or after the transparent conductive film is coated on the transparent substrate, and may be formed to overlap the transparent conductive film along an edge of an equipotential forming region of the transparent substrate.

The resistance value may be changed by changing a number of patterns for each unit length of the closed-loop electrode with respect to the horizontal direction or the vertical direction between the signal connection terminals.

Also, the resistance value may be changed by changing a material of the closed-loop electrode with respect to the horizontal direction or the vertical direction between the signal connection terminals.

Also, the resistance value may be changed by changing a line width or a thickness of the closed-loop electrode with respect to the horizontal direction or the vertical direction between the signal connection terminals.

The closed-loop electrode may be patterned into at least one of a linear pattern, a square-zigzagged pattern, a triangular saw pattern, and a wave pattern between the signal connection terminals.

The touch panel may further include an auxiliary electrode being spaced apart from the closed-loop electrode by a predetermined distance along the closed-loop electrode. The auxiliary electrode may include: a first electrode being separated from a pattern of the closed-loop electrode in the horizontal direction or the vertical direction between the signal connection terminals; and a second electrode being connected to at least one point of the pattern of the closed-loop electrode in the horizontal direction or the vertical direction between the signal connection terminals. The second electrode may be connected to a horizontal central point of the closed-loop electrode or a vertical central point thereof.

The signal connection terminals may be connected to a pattern of the closed-loop electrode using the same material, or may be separated from the pattern of the closed-loop electrode. Also, the signal connection terminals may include four signal access terminals that are located in corners, respectively.

The closed-loop electrode may be formed according to any one of a printing, a deposition, an inkjet printing, and a Podell.

According to still another aspect of the present invention, there is provided a method of manufacturing a touch panel for a touch screen, including: coating a transparent conductive film on a transparent substrate; and forming a closed-loop electrode for forming an equipotential in which a resistance value for each unit length changes with respect to the horizontal direction or the vertical direction between a plurality of signal connection terminals.

### Effect

According to the present invention, a touch panel in which an equipotential forming electrode may be formed in a seamless continuously-connected closed loop to eliminate the linearity distortion of equipotential lines in the edge of a transparent conductive substrate, that is, in around the equipotential forming electrode. Accordingly, it is possible to reduce a dead zone and maximize an active region.

Also, according to the present invention, a touch panel forming which an equipotential forming electrode may be formed in a simple pattern such as a linear pattern, a square-zigzagged pattern, a triangular saw pattern, and a wave pattern. Accordingly, it is possible to reduce a pattern forming area and expand the total viewing region on a transparent conductive substrate to thereby readily achieve the symmetric structure in a pattern forming process.

Also, according to the present invention, a touch panel in which an equipotential forming electrode may be selected based on various types of shapes, various electrical conductivity (terminal resistance), various sizes (line width), and the like to be applicable to a touch screen of a small device such as a mobile phone. Accordingly, it is possible to provide a touch panel appropriate for various types of standards of a client.

Also, according to the present invention, even when applying a closed-loop electrode to a touch screen of a small mobile, the resistance between terminals may be increased and the power consumption may be reduced by using a scheme of calibrating the increasing linearity distortion of equipotential lines as resistance of a closed-loop electrode increases in order to prevent the terminal resistance from decreasing as the size is smaller.

Also, according to the present invention, the resistance between terminals may be increased in a small device and the power consumption may be reduced by using a scheme of changing the density of elements of each unit length of a closed-loop electrode, or a scheme of separating the closed-loop electrode from a signal connection terminal, a scheme of adding an auxiliary electrode to the closed-loop electrode, and the like. In the closed-loop electrode, an equipotential forming electrode may be formed in a simple pattern such as a linear pattern, a square-zigzagged pattern, a triangular saw pattern, and a wave pattern.

### BRIEF DESCRIPTION OF DRAWINGS

FIG. 1 is a perspective view for describing the structure of a capacitive touch panel according to a conventional art;

FIG. 2 is a perspective view for describing the structure of a 5-line touch panel of a resistive type according to the conventional art;

FIG. 3 is a top view illustrating an example of a pattern of an equipotential forming electrode according to the conventional art;

FIG. 4 is a top view for describing a relation between an active region and the equipotential formed in FIG. 3;

FIG. 5 is a top view for describing a touch panel with an equipotential forming electrode according to an embodiment of the present invention;

FIG. 6 is a top view for describing a touch panel with an equipotential forming electrode according to another embodiment of the present invention;

FIG. 7 is a top view for describing a touch panel with an equipotential forming electrode according to still another embodiment of the present invention;

FIG. 8 is a top view for describing a touch panel with an equipotential forming electrode according to yet another embodiment of the present invention;

FIG. 9 is a top view for describing a touch panel with an equipotential forming electrode according to a further another embodiment of the present invention;

FIG. 10 is a top view for describing a touch panel with an equipotential forming electrode according to still another embodiment of the present invention;

FIG. 11 is a partial top view for describing results when increasing resistance of a closed-loop electrode for forming equipotential by five times according to an embodiment of the present invention;

FIG. 12 is a partial top view for describing a touch panel when changing a resistance value for each unit length of a closed-loop electrode for forming equipotential according to an embodiment of the present invention;

FIG. 13 is a partial top view for describing a touch panel when adding an auxiliary electrode to a closed-loop electrode for forming equipotential according to an embodiment of the present invention;

FIG. 14 is a partial top view for describing a touch panel when a closed-loop electrode is spaced apart from a signal connection terminal according to an embodiment of the present invention; and

FIG. 15 is a partial top view for describing a touch panel when adding an auxiliary electrode to a view shown in FIG. 14.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

Hereinafter, the present invention will be described in detail with reference to the accompanying drawings.

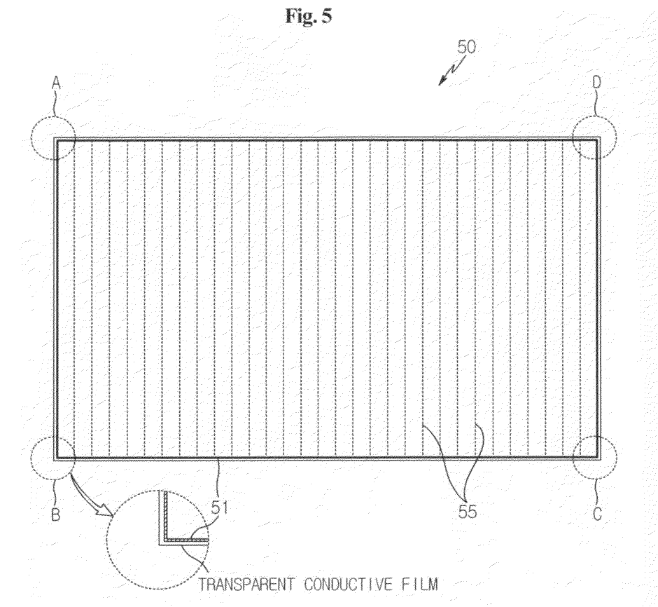

FIG. 5 is a top view for describing a touch panel 50 with an equipotential forming electrode 51 according to an embodiment of the present invention. Referring to FIG. 5, the touch panel 50 includes the equipotential forming electrode 51. The equipotential forming electrode 51 consists of a linear metal electrode that is patterned into a closed loop. The equipotential forming electrode 51 includes signal connection terminals A, B, C, and D in corners, respectively. Necessary signals may be applied to around the signal connection terminals A, B, C, and D (electrode capable of applying or detecting voltage and current) through appropriate wiring. In this embodiment, the signal connection terminal is included in each corner, but the present invention is not limited thereto. Specifically, each side may further include other terminals to apply signals or to interpret the change in the signals.

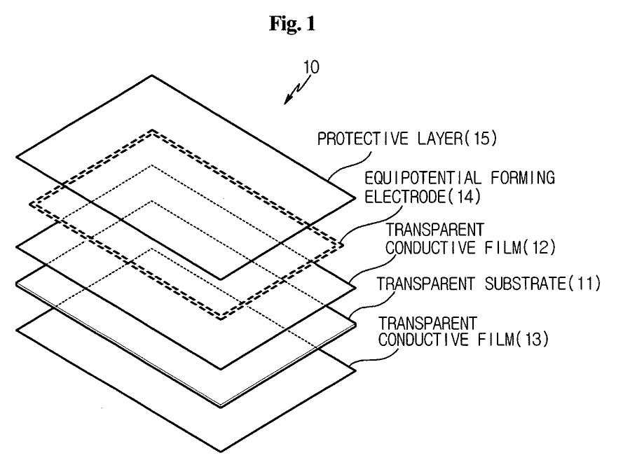

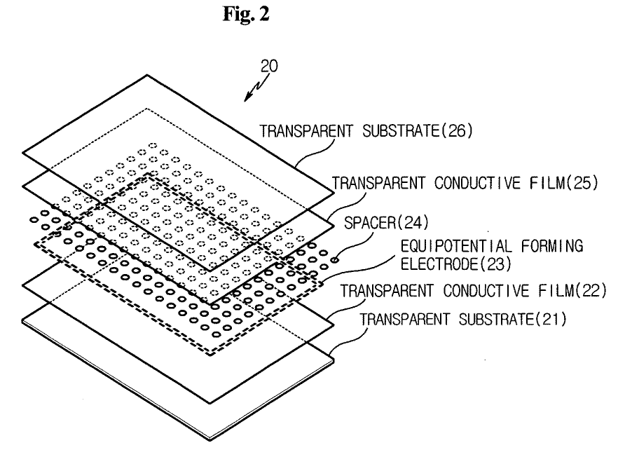

As described above with reference to FIGS. 1 and 2, a touch panel according to the present invention may be used for a 5-line touch screen of a resistive type, or may be used for a capacitive touch screen.

A coated film is provided on a transparent substrate that is made of, for example, a glass, polyethylene terephthalate (PET), poly carbonate (PC), poly methyl methacrylate (PMMA), and the like. The coated film may be coated with a transparent conductive oxide (TCO) thin film such as indium tin oxide (ITO), al doped zinc oxide (AZO), antimony tin oxide (ATO), and the like. Also, the coated film may be coated with a half mirror thin film such as aluminum (Al), nickel (Ni), chromium (Cr), stainless steel (SUS), tin (Ti), and the like. Also, the coated film may be coated with other conductive transparent film (conductive film for forming the potential distribution to detect a touch location). The equipotential forming electrode 51 is formed on the conductive transparent film layer. Also, the equipotential forming electrode 51 may be formed on the transparent substrate and then the conductive transparent film layer may be coated thereon. Specifically, the equipotential forming electrode 51 overlaps the transparent conductive film to be patterned along the edge of an equipotential forming region of the transparent substrate. The equipotential forming electrode 51 is formed in a closed-loop electrode.

The equipotential forming electrode 51 may use a material that is different from a material of the transparent conductive film and is more conductive than the material of the transparent conductive material. For example, the equipotential forming electrode 51 may use a metal material such as aluminum (Al), silver (Ag), copper (Cu), chromium (Cr), nickel (Ni) stainless steel (SUS), tin (Ti), ITO, AZO, and ATO, alloys thereof, or the layer structure thereof, for example, Cr—Cu—Cr layer structure. In the present invention, it may be preferable that resistance between two signal connection terminals, for example, the resistance of A-B, B-C, C-D, and D-A is the same as a value less than or equal to 10 kilo ohms. However, the present invention is not limited thereto. Accordingly, the resistance between facing horizontal patterns, for example, the resistance of B-C may be the same as the resistance of D-A, whereas the resistance between facing vertical patterns, for example, the resistance of A-B and the resistance of C-D may be the same as each other but may have a different value from the horizontal pattern resistance. As described above, when the vertical pattern resistance is different from the horizontal pattern resistance, the power consumption when forming the equipotential on the x axis may be different from the power consumption when forming the equipotential on the y axis. The equipotential distortion, for example, the linearity distortion, may be slightly different. Also, the resistance of A-B, the resistance of B-C, the resistance of C-D, and the resistance of D-A may be all different from each other. In this case, the distorted linearity of equipotential lines may be solved by appropriate use of a four point calibration or an eight point calibration.

Basically, it may be preferable to form two horizontal sides between the signal connection terminals, for example, the horizontal patterns formed between B and C, and between D and A, in the same pattern to have the same resistance. Also, it may be preferable to form two vertical sides between the signal connection terminals, for example, the vertical patterns between A and B, and between C and D in the same pattern to have the same resistance. FIG. 5 illustrates an example of patterning the vertical patterns and the horizontal patterns in the same linear pattern. If the pattern shape satisfies a resistance value, it is possible to pattern the electrode into a square-zigzagged pattern, a triangular saw pattern, and a wave pattern, or the combination thereof. The resistance of the equipotential forming electrode 51 may be determined to a required value by selecting a material to thereby change the electrical conductivity, or by changing the thickness of a pattern or the line width thereof.

In the case of a capacitive scheme, in order to interpret the x coordinate, 0 volt may be applied to the signal connection terminals A and B and a certain high frequency signal may be applied to the signal connection terminals C and D. In order to interpret the y coordinate, 0 volt may be applied to the signal connection terminals B and C and the certain high frequency signal may be applied to the signal connection terminals A and D. In the case of the 5-line touch screen, in order to interpret the x coordinate, 0 volt may be applied to the signal connection terminals A and B and a certain direct current (DC) signal, for example, 5 volts may be applied to the signal connection terminals C and D. In order to interpret the y coordinate, 0 volt may be applied to the signal connection terminals B and C and the certain DC signal, for example, 5 volts may be applied to the signal connection terminals A and D.

As described above, when signals are applied to the signal connection terminals A, B, C, and D, and then a finger, a pen, and the like is contacted, coordinates (x, y) of the contacting location of the finger may be interpreted by reading the change in the signals via another transparent conductive film 13 of FIG. 1, or 26 of FIG. 2.

The equipotential forming electrode 51 may uniformly distribute potential on the transparent conductive film disposed on the transparent substrate to thereby enable the contacting location of the finger to be accurately interpreted. When signals are applied to the signal connection terminals A, B, C, and D in order to interpret the x coordinate, equipotential may be vertically formed between the facing horizontal patterns like equipotential lines 55. When signals are applied to the signal connection terminals A, B, C, and D in order to interpret the y coordinate, equipotential may be horizontally formed between the facing vertical patterns.

According to the present invention, like the equipotential lines 55, the linearity distortion of equipotential lines is mostly eliminated near to the equipotential forming electrode 51. Therefore, it is possible to reduce a dead zone and maximize an active region. Although not shown, equipotential lines may be formed between the vertical patterns. Also, since the equipotential forming electrode 51 is formed in a simple linear pattern, a pattern forming area may be reduced to make all the regions excluding a portion corresponding to the equipotential forming electrode 51 as a viewing region on the TCO substrate. In this pattern forming process, it is possible to readily obtain the symmetric structure.

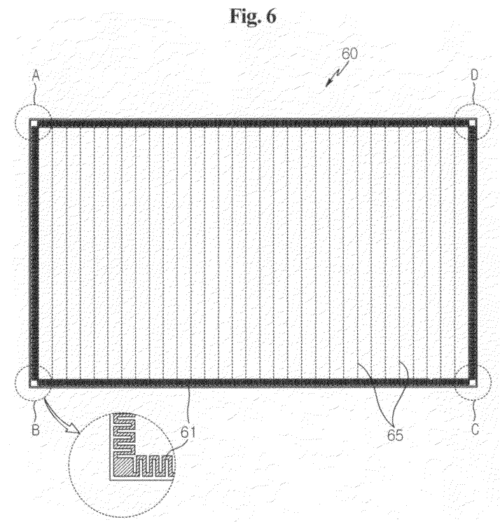

FIG. 6 is a top view for describing a touch panel 60 with an equipotential forming electrode 61 according to another embodiment of the present invention.

Referring to FIG. 6, the touch panel 60 consists of a metal electrode that is patterned into a closed loop of a square-zigzagged pattern. The touch panel 60 includes signal connection terminals A, B, C, and D (electrode capable of applying or detecting voltage and current). Similar to FIG. 5, signals may be applied to the signal connection terminals A, B, C, and D that are disposed in corners respectively, through appropriate wiring. In this embodiment, the signal connection terminal is included in each corner, but the present invention is not limited thereto. Specifically, each side may further include other terminals to apply signals or to interpret the change in the signals.

Before or after coating a transparent conductive film on a transparent substrate made of, for example, a glass, PET, PC, PMMA, and the like, the equipotential forming electrode 61 is formed. Specifically, the equipotential forming electrode 51 overlaps the transparent conductive film to be patterned along the edge of an equipotential forming region of the transparent substrate. In particular, the equipotential forming electrode 61 is formed in a closed-loop electrode of the square-zigzagged pattern.

As described above with reference to FIG. 5, the equipotential forming electrode 61 may use a metal material that is more conductive than the transparent conductive material. For example, the equipotential forming electrode 61 may use a conductive material such as Al, Ag, Cu, Cr, Ni, SUS, Ti, ITO, AZO, and ATO, alloys thereof, or the layer structure thereof, for example, Cr—Cu—Cr layer structure. It may be preferable that resistance between two signal connection terminals, for example, the resistance of A-B, B-C, C-D, and D-A is the same as a value less than 10 kilo ohms. Also, as described above with reference to FIG. 5, only the facing horizontal patterns may have the same resistance value. Also, all the horizontal patterns and the vertical patterns may have a different resistance value.

Here, even in the case of the zigzagged metal electrode, the horizontal patterns and the vertical patterns may be patterned in the same shape. Also, the vertical patterns have the same shape, whereas the horizontal patterns may have the same shape, but have the different shape from the vertical patterns. Specifically, if the pattern shape satisfies the resistance value, it is possible to pattern the electrode into a square-zigzagged pattern, a triangular saw pattern, and a wave pattern, or the combination thereof. The resistance of the equipotential forming electrode 61 may be determined to a required value by selecting a material to thereby change the electrical conductivity, or by changing the thickness of a pattern or the line width thereof.

As described above with reference to FIG. 5, when signals are applied to the signal connection terminals A, B, C, and D, and then a finger, a pen, and the like is contacted, coordinates (x, y) of the contacting location of the finger may be interpreted by reading the change in the signals via another transparent conductive film 13 of FIG. 1, or 26 of FIG. 2. In this instance, like the equipotential lines 65, the linearity distortion of equipotential lines is mostly eliminated near to the equipotential forming electrode 61. Therefore, it is possible to reduce a dead zone and maximize an active region. Although not shown, equipotential lines may be formed between the vertical patterns. Due to the equipotential forming electrode 61 in the square-zigzagged pattern, potentials are uniformly distributed on the transparent conductive film disposed on the transparent substrate. Accordingly, the contacting location of the finger may be accurately interpreted. When interpreting the x coordinate, equipotential may be vertically formed between the facing horizontal patterns like the equipotential lines 65. When interpreting the y coordinate, equipotential may be horizontally formed between the facing vertical patterns. As shown in FIG. 6, the linearity distortion of equipotential lines is mostly eliminated near to the equipotential forming electrode 61.

In the equipotential forming electrode 61, an area occupied by the simple zigzagged pattern is reduced in comparison to the conventional art. Therefore, it is possible to make all the regions excluding a portion corresponding to the equipotential forming electrode 61 as the viewing region. In the pattern forming process, it is possible to readily obtain the symmetric structure.

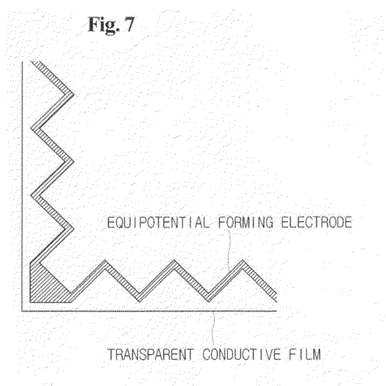

FIG. 7 is a top view for describing a touch panel with an equipotential forming electrode according to still another embodiment of the present invention. As shown in FIG. 7, the pattern of the equipotential forming electrode 51 of FIG. 5 or 61 of FIG. 6 may be replaced with a triangular saw pattern. Also, the equipotential forming electrode 51 or 61 may be formed by combining the patterns.

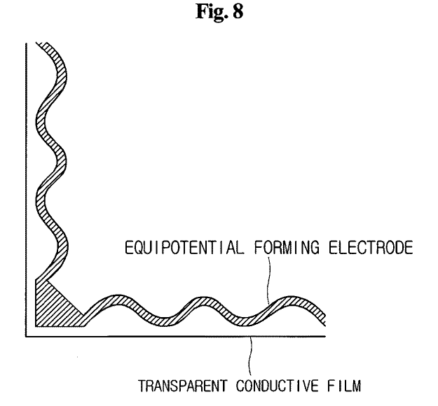

FIG. 8 is a top view for describing a touch panel with an equipotential forming electrode according to yet another embodiment of the present invention. As shown in FIG. 8, the pattern of the equipotential forming electrode 51 of FIG. 5 or 61 of FIG. 6 may be replaced with a wave pattern. Also, the equipotential forming electrode 51 or 61 may be formed by combining the patterns.

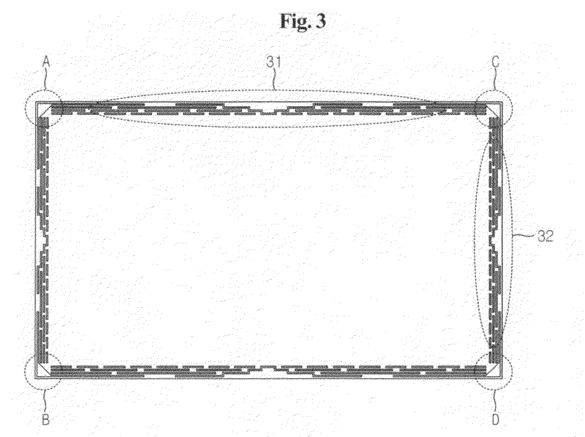

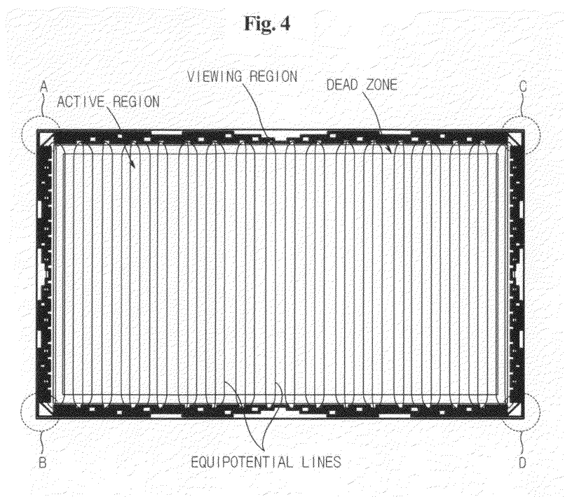

As shown in FIGS. 5 and 6, according to the present invention, the linearity of equipotential lines may be significantly improved in comparison to the conventional art of FIG. 3. In particular, since the linearity distortion is almost eliminated near to the equipotential forming electrode 51 or 61, the dead zone may be mostly disappeared.

In FIG. 5, since the line width of the equipotential electrode 51 can be adjusted to less than about 0.1 mm, it may be very advantageous to be applicable to a touch screen of a small device such as a mobile phone and the like. When the equipotential forming electrode 51 is formed to make the resistance between signal connection terminals about tens of ohms, the power consumption may be increased. In this case, it is possible to prevent the power consumption from relatively increasing by reducing signal processing sweeping for interpreting coordinates (x, y) and reducing the voltage applying time.

In FIG. 6, it is possible to increase the resistance between two signal connection terminals to hundreds of ohms. In this instance, the linearity may be slightly reduced without the linearity distortion near to the equipotential forming electrode 61 (without loss of the dead zone). In this case, it is possible to solve the above problem according to an appropriate calibration algorithm such as an eight-point, calibration and the like. Therefore, the above problem is negligible.

In the example of FIG. 5, it is difficult to form the equipotential forming electrode 51 of the line width less than about 0.1 mm (currently possible to about 0.03 mm) using a general silk screen printing. Therefore, a thick film within about 10 micro meters is formed to make the thickness of the equipotential forming electrode 51 to less than tens of ohms in a small device such as a cellular phone. In the case of forming the patterns as shown in FIG. 6 to increase the resistance, even though the line width of the equipotential forming electrode 61 is within some mm, it is possible to increase the resistance between signal connection terminals to greater than hundreds of ohms without the dead zone. In addition to the square-zigzagged pattern, when applying a curved shape such as the triangular saw pattern of FIG. 7, the wave pattern of FIG. 8, and the like, it is possible to increase the resistance.

In addition to the general printing, the pattern of the equipotential forming electrode 51 or 61 may be formed according to any one of a deposition, an inkjet printing, a Podell. As described above, it is possible to control terminal resistance by adjusting the thickness of a conductive material such as Al, Ag, Cu, Cr, Ni, SUS, Ti, ITO, AZO, and ATO, or alloys thereof, or the layer structure thereof, for example, Cr—Cu—Cr layer structure.

As described above, according to the simple printing, the thickness of a metal electrode is controlled within the range of 5 micro meters through 15 micro meters and the line width of the metal member is about minimum 30 micro meters. Therefore, in the case of a small device, resistance is very small as tens of ohms and thus the power consumption may be increased. However, as described above, there are various types of manners that can increase the length of a pattern for increasing resistance. Examples thereof have been described above with reference to FIGS. 6 through 8. It is possible to increase the length of the pattern to thereby increase the resistance using various types of patterns, such as the square-zigzagged pattern, the triangular saw pattern, and the wave pattern.

In the above example, a method of contacting a glass mask, a metal shadow mask, or a vinyl mask with a substrate and then disposing a metal may be used. Examples of the disposition may include various types of schemes such as a scheme of disposing a metal via an electron beam or a sputter, exposing the metal using a mask, and then etching the metal.

Currently, the development of inkjet printing is ongoing. It is possible to form the pattern of the equipotential forming electrode 51 or 61 using a highly conductive ink, for example, Ag ink, and the like. Also, like the Podell used for forming an electrode of a plasma display panel (PDP), it is possible to form the pattern of the equipotential forming electrode 51 or 61 using photosensitive silver paste.

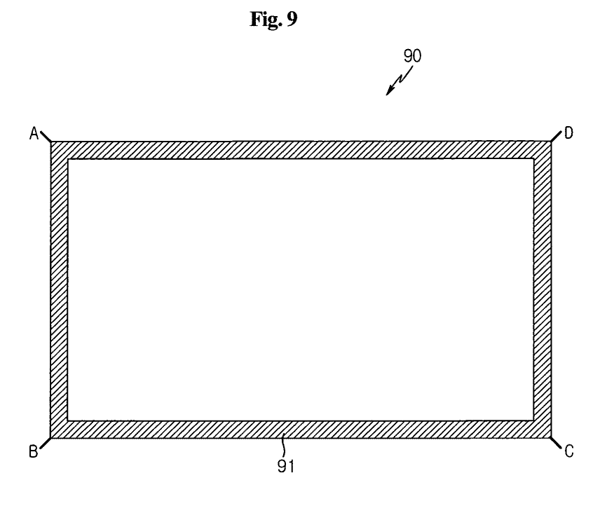

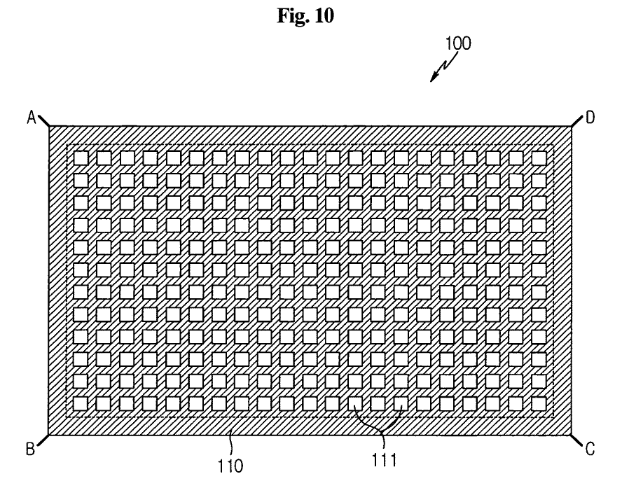

In addition, an equipotential forming electrode in the form of the above-described closed-loop electrode may be formed as shown in FIGS. 9 and 10.

FIG. 9 is a top view for describing a touch panel 90 with an equipotential forming electrode 91 according to a further another embodiment of the present invention.

Referring to FIG. 9, in the touch panel 90, a closed-loop electrode for forming equipotential may not be patterned into a certain shape in an inner place of a substrate as described above with reference to FIGS. 5 through 8. The closed-loop electrode may be formed by expanding the equipotential forming electrode 91 of the constant width to the edge of the substrate.

Specifically, the equipotential forming electrode 91 may be formed through a patterning process of forming a conductive thin film on the entire surface of a substrate according to a general printing, a disposition, an inkjet printing, a Podell, and the like, eliminating a region excluding a portion corresponding to the equipotential forming electrode 91, that is, a portion corresponding to the closed-loop electrode as shown in FIG. 9, and thereby expanding the closed-loop electrode of the constant width to the edge of the substrate. Here, the conductive thin film may be a half mirror thin film such as Al, Ag, Cu, Cr, Ni, SUS, Ti, and the like, or a highly conductive TCO thin film such as ITO, AZO, ATO, and the like, or alloys thereof, or the layer structure thereof.

Predetermined locations of corners of the formed equipotential forming electrode 91 are used for the touch panel 90 as signal connection terminals A, B, C, and D (electrode capable of applying or detecting voltage and current), respectively. Through this, it is possible to form equipotential without almost any horizontal or vertical linearity distortion of equipotential lines. Even when using the equipotential forming electrode 91, it is possible to significantly reduce the area of the equipotential forming electrode 91 on the substrate in comparison to the conventional art by reducing the resistance between the signal connection terminals to less than 10 kilo ohms, or by using a predetermined calibration algorithm. Accordingly, it is possible to use, as a viewing region, almost all the regions excluding a portion corresponding to the equipotential forming electrode 91. In this pattern forming process, it is possible to readily obtain the symmetric structure.

FIG. 10 is a top view for describing a touch panel 100 with an equipotential forming electrode 110 according to still another embodiment of the present invention

Referring to FIG. 10, in the touch panel 100, a closed-loop electrode for forming equipotential may not be patterned into a certain shape in an inner place of a substrate as described above with reference to FIGS. 5 through 8. The closed-loop electrode may be formed by expanding the equipotential forming electrode 110 to the edge of the substrate and may be formed as a transparent conductive film in a mesh where a plurality of patterns 111 in a certain shape is eliminated.

Specifically, the equipotential forming electrode 110 may be formed through a patterning process of forming a conductive thin film on the entire surface of a substrate according to a general printing, a disposition, an inkjet printing, a Podell, and the like, and then eliminating the plurality of patterns 111 in the certain shape in an inner region of the substrate that is spaced apart from the edge by a predetermined distance, as shown in FIG. 10. Here, the conductive thin film may be half mirror thin film such as Al, Ag, Cu, Cr, Ni, SUS, Ti, and the like, a highly conductive TCO thin film such as ITO, AZO, ATO, and the like, alloys thereof, or the layer structure thereof.

The equipotential forming electrode 110 in the form of the mesh is to increase the average resistance and improve permeability in comparison to a closed-loop pattern that remains in the edge. The plurality of patterns may be regular patterns such as a circle, a triangle, a square, a line, and the like. For example, when the plurality of patterns is in the square pattern as shown in FIG. 10, each pattern may be patterned to less than hundreds of micro meters that is much smaller than a portion contacting with an instrument such as a finger, a pen, and the like. In this instance, the width of a remaining patterned conductive thin film may be tens of micro meters and may maintain a high permeability, which will be described later. In this case, an etched region of the contacting portion may remain only on the transparent substrate. Consequently, the average permeability on the remaining patterned conductive thin film region and the remaining etched transparent substrate region may increase. Similarity, it is possible to form a closed-loop electrode for forming equipotential in the form of a conductive transparent thin film, with increasing the average sheet resistance of the patterned substrate. Another transparent conductive film as shown in FIGS. 5 through 9 may be used as the conductive thin film, preferably, not overlapping the transparent conductive film.

Predetermined locations of corners of the equipotential forming electrode 110 formed in the mesh form are used as signal connection terminals A, B, C, and D for the touch panel 100, respectively. Through this, it is possible to form equipotential without almost any horizontal or vertical linearity distortion of equipotential lines with respect to the horizontal and vertical direction. Even when using the equipotential forming electrode 110, it is possible to significantly reduce the area of the equipotential forming electrode 110 on the substrate in comparison to the conventional art by reducing the resistance between the signal connection terminals to less than 10 kilo ohms, or by using a predetermined calibration algorithm. Accordingly, it is possible to use, as a viewing region, all the regions excluding a portion corresponding to the equipotential forming electrode 110. In this pattern forming process, it is possible to readily obtain the symmetric structure.

When applying the above-described closed-loop electrode for forming equipotential that can be formed in various types of shapes to a touch panel for a mobile touch screen, the resistance between the signal connection terminals may be too small, increasing the power consumption. When arbitrarily increasing the resistance of the closed-loop electrode in order to prevent the resistance between terminals from significantly decreasing in a small device, the linearity of equipotential lines may be distorted and coordinates may be unstably interpreted.

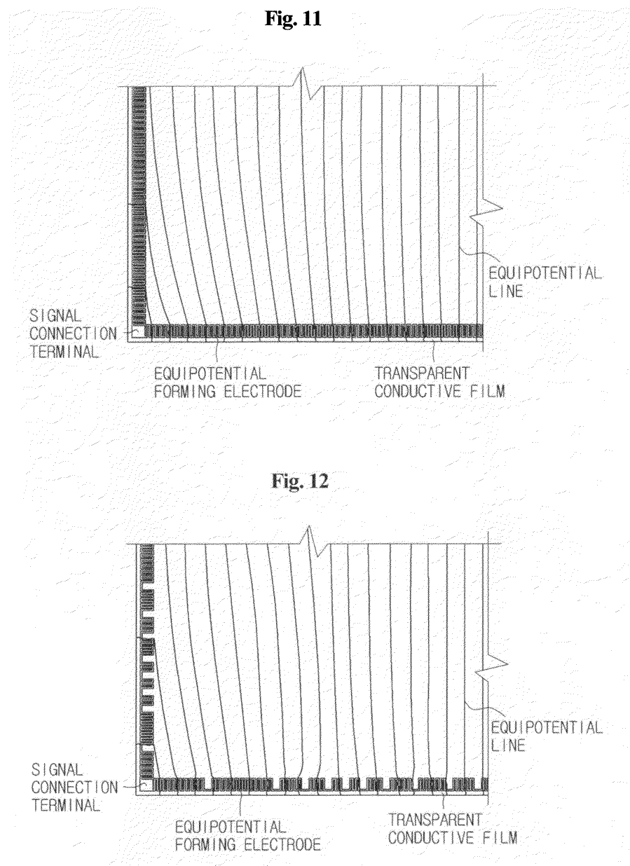

FIG. 11 is a partial top view for describing results based on a finite element analysis (FEA) when increasing resistance of a closed-loop electrode for forming equipotential according to an embodiment of the present invention. Due to the above-described reasons, when reducing conductivity of a material, a line width, a thickness, and the like of the closed-loop electrode to thereby increase a resistance value for application to a small device, the linearity distortion of equipotential lines may be increased as the equipotential line is located further from the center of the x axis, as shown in FIG. 11.

Accordingly, even though the closed-loop electrode is applied to a small mobile touch screen, the linearity distortion of equipotential lines should be calibrated in order to increase the resistance between terminals to some extent and to reduce the power consumption. In order to increase the resistance between terminals and to calibrate the linearity distortion, there is offered a method that can change a resistance value by changing a number of patterns for each unit length of the closed-loop electrode with respect to the horizontal direction or the vertical direction between signal connection terminals, or by changing the line width or the thickness of the closed-loop electrode, or by making the density of elements of the closed-loop electrode irregular with respect to the horizontal direction or the vertical direction. Also, it is possible to increase the resistance between terminals in a small device and thereby reduce the power consumption by spacing the signal connection terminal apart from the closed-loop electrode, by adding an auxiliary electrode to the closed-loop electrode, and the like, which will be described later.

FIG. 12 is a partial top view for describing a touch panel when changing a resistance value for each unit length of a closed-loop electrode for forming equipotential according to an embodiment of the present invention. As shown in FIG. 12 that illustrates a quarter of a left lower portion of the touch panel, the closed-loop electrode for forming equipotential is formed to overlap a transparent conductive film along an edge of an equipotential forming region of a transparent substrate. In this instance, the resistance value for each unit length may change by changing a number of patterns for each unit length of the closed-loop electrode with respect to the horizontal direction or the vertical direction between signal connection terminals. The closed-loop electrode may be formed before or after the transparent conductive film is coated on the transparent substrate. For example, by making the density of the zigzagged pattern inconsistent with respect to the horizontal direction or the vertical direction, that is, by changing the density for each location, it is possible to obtain the change in the line resistance of the closed-loop electrode. Accordingly, in comparison to the touch panel shown in FIG. 11, it can be seen that the linearity of equipotential lines is improved in corners and the distortion is calibrated. As described above, when changing the density distribution for each location by changing a number of zigzagged patterns for each unit length in a corresponding location, it is possible to change electrical resistance (resistivity, line resistance, or sheet resistance) in the corresponding location. It is possible to enable the change in the number of patterns to have a predetermined regularity. Also, it is possible to irregularly change the number of patterns, disposing linear patterns to form the linearity without a particular pattern in a predetermined location depending on a characteristic of the touch panel.

As described above, it is possible to change a resistance value by changing the number of patterns for each unit length of the closed-loop electrode with respect to the horizontal direction or the vertical direction between the signal connection terminals, or by changing material of the closed-loop electrode to regularly or irregularly have a different conductivity in each location, or by changing the line width or the thickness of the closed-loop electrode for each location. The above schemes may be applicable to all the cases such as when the closed-loop electrode for forming equipotential is in a linear pattern, a square-zigzagged pattern, a triangular saw pattern, a wave pattern, and the like. In particular, when the closed-loop electrode is in only the linear pattern, it is impossible to change the number of patterns for each unit length. Therefore, it is possible to change the resistance according to the above-described schemes excluding this.

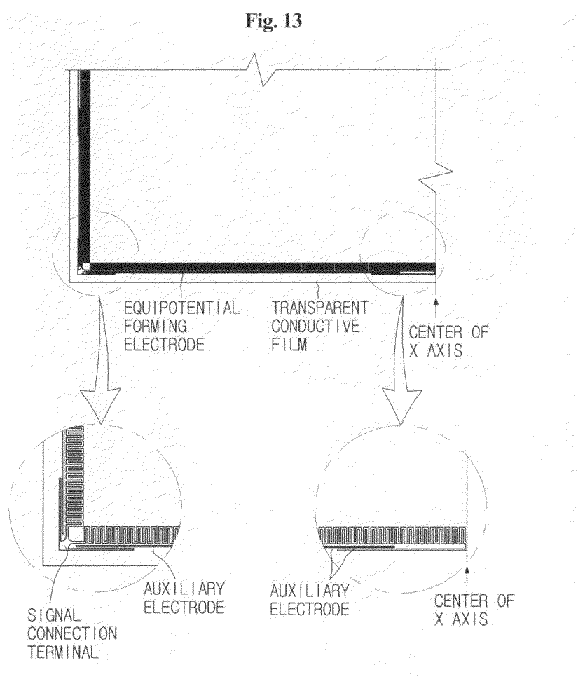

FIG. 13 is a partial top view for describing a touch panel when adding an auxiliary electrode to a closed-loop electrode for forming equipotential according to an embodiment of the present invention. As shown in FIG. 13 that illustrates a quarter of a left lower portion of the touch panel, it is possible to further improve the linearity of equipotential lines by including the auxiliary electrode that is spaced apart from the closed-loop electrode for forming equipotential along the closed-loop electrode. It may be preferable to form the auxiliary electrode with respect to the horizontal direction and the vertical direction between signal connection terminals, that is, with respect to the x axis and the y axis. As shown in FIG. 13, in order to symmetrically calibrate equipotential on the touch panel with respect to the horizontal direction and the vertical direction, it is possible to include the auxiliary electrode separated from a pattern of the closed-loop electrode and the auxiliary electrode connected to a central point of the pattern of the closed-loop electrode in each direction. The auxiliary electrode connected to the pattern of the closed-loop electrode in the central point of each direction may calibrate the asymmetry that may occur due to the difference in the sheet resistance of the transparent conductive film, the thickness and the width of the closed-loop electrode wiring, the line resistance, and the like, when actually manufacturing the touch panel.

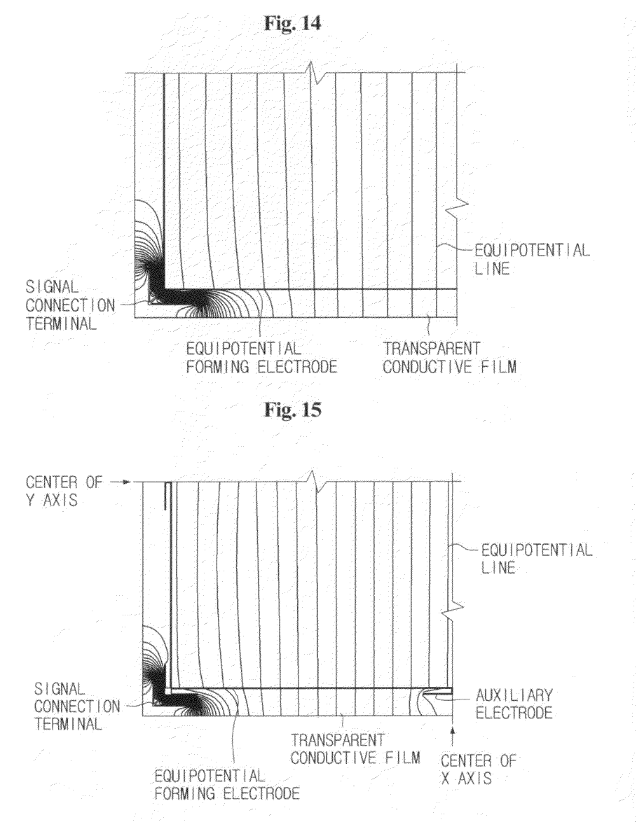

FIG. 14 is a partial top view for describing a touch panel when a closed-loop electrode is spaced apart from a signal connection terminal according to an embodiment of the present invention. As described above, when forming the closed-loop electrode for forming equipotential, it is possible to connect the closed-loop electrode to the signal connection terminal in each corner using the same material. However, the present invention is not limited thereto. Specifically, as shown in FIG. 14 that illustrates a quarter of a left lower portion of the touch panel, in order to increase resistance in a small device or to improve the linearity of equipotential lines, it is possible to separate the signal connection terminal from the pattern of the closed-loop electrode in each corner. In this instance, signals may be transferred from the signal connection terminals to the closed-loop electrode via the transparent conductive film. FIG. 14 illustrates the closed-loop electrode in the linear pattern, but the present invention is not limited thereto. Specifically, the closed-loop electrode may be in a square-zigzagged pattern, a triangular saw pattern, a wave pattern, and the like. In this instance, it is possible to change a resistance value with respect to the horizontal direction or the vertical direction by changing a number of patterns for each unit length of the closed-loop electrode with respect to the horizontal direction or the vertical direction between the signal connection terminals, or by changing a material of the closed-loop electrode, or by changing the line width or the thickness of the closed-loop electrode. When the signal connection terminal is spaced apart from the closed-loop electrode by a predetermined distance, the signal connection terminal may firstly form the potential distribution via the transparent conductive film. The potential distribution may be electrically connected via the transparent conductive film and the internally existing closed-loop electrode for forming equipotential enables the potential distribution to have the linearity in a touch region.

FIG. 15 is a partial top view for describing a touch panel when adding an auxiliary electrode to a view shown in FIG. 14. Even when the signal connection terminal is spaced apart from the closed-loop terminal as shown in FIG. 15, it is possible to apply the auxiliary electrode according to the same scheme of FIG. 13. Accordingly, it is possible to adjust the first potential distribution between the signal connection terminal and the closed-loop electrode via the auxiliary electrode to thereby improve the linearity of equipotential lines. Also, as described above, it is possible to connect the auxiliary electrode to the closed-loop electrode in a center of each direction. When the closed-loop electrode is spaced apart from the signal connection terminal, the resistance between the signal connection terminals may significantly change by adjusting the distance between the closed-loop electrode and the signal connection terminals. In order to increase the potential difference of the closed-loop electrode, that is, in order to increase the resistance difference between the terminals of the closed-loop electrode, when forming the closed-loop electrode in a zigzagged pattern, a triangular saw pattern, a wave pattern, and the like, it is possible to change a resistance value with respect to the horizontal direction or the vertical direction by changing a number of patterns for each unit length of the closed-loop electrode with respect to the horizontal direction or the vertical direction between the signal connection terminals, or by changing a material of the closed-loop electrode, or by changing the line width or the thickness of the closed-loop electrode. As described above, the closed-loop electrode may be formed according to a printing, a disposition, an inkjet printing, a Podell, and the like.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

The present invention may be adopted to implement a touch screen for display of various electronic devices as well as a cellular phone or other small systems.

1. A touch panel for a touch screen, comprising:
a transparent conductive film and an equipotential forming electrode on a transparent substrate,
wherein the equipotential forming electrode is formed before or after the transparent conductive film is coated on the transparent substrate, and the equipotential forming electrode comprises a closed-loop electrode that is formed to overlap the transparent conductive film along an edge of an equipotential forming region of the transparent substrate.

2. The touch panel of claim 1, wherein a material of the closed-loop electrode has an electrical conductivity greater than a material of the transparent conductive film.

3. The touch panel of claim 1, wherein a material of the closed-loop electrode comprises at least one of indium tin oxide (ITO), al doped zinc oxide (AZO), antimony tin oxide (ATO), aluminum (Al), nickel (Ni), chromium (Cr), stainless steel (SUS), tin (Ti), and silver (Ag).

4. The touch panel of claim 1, wherein the closed-loop electrode comprises:
a plurality of signal connection terminals being connected to a pattern of the closed-loop electrode using the same material, or being separated from the pattern of the closed-loop electrode, and
the resistance of the closed-loop electrode between the signal connection terminals is less than or equal to 10 kilo ohms.

5. The touch panel of claim 1, wherein the closed-loop electrode is patterned into at least one of a linear pattern, a square-zigzagged pattern, a triangular saw pattern, and a wave pattern, between the signal connection terminals.

6. The touch panel of claim 1, wherein the touch panel is used for a 5-line resistive touch screen or a capacitive touch screen.

7. The touch panel of claim 1, further comprising:
an auxiliary electrode being spaced apart from the closed-loop electrode by a predetermined distance along the closed-loop electrode.

8. A touch panel for a touch screen, comprising:
a transparent conductive film and an equipotential forming electrode on a transparent substrate,
wherein the equipotential forming electrode is formed before or after the transparent conductive film is coated on the transparent substrate, and the equipotential forming electrode comprises a closed-loop electrode that is formed to overlap the transparent conductive film along an edge of an equipotential forming region of the transparent substrate, and
the closed-loop electrode is formed in a pattern with a constant width from the edge of the transparent substrate by forming a predetermined conductive thin film on the entire surface of the transparent substrate and eliminating a region excluding a portion corresponding to the closed-loop electrode.

9. A touch panel for a touch screen, comprising:
an equipotential forming electrode on a transparent substrate,
wherein the equipotential forming electrode is formed in a closed-loop electrode along an edge of an equipotential forming region of the transparent substrate and comprises a plurality of signal connection terminals, and
the closed-loop electrode is formed by forming a predetermined conductive thin film on the entire surface of the transparent substrate and then eliminating a plurality of patterns in a predetermined shape in an inner region of the transparent substrate that is spaced apart from the edge by a predetermined distance.

10. A touch panel comprising:
a transparent substrate;
a transparent conductive film being coated on a predetermined layer disposed on the transparent substrate; and
an equipotential forming electrode being formed before or after the transparent conductive film is coated on the transparent substrate, to overlap the transparent electrode film along an edge of an equipotential forming region of the transparent substrate,
wherein the equipotential forming electrode comprises:
four signal connection terminals being located in corners, respectively;
horizontal patterns being formed in two horizontal sides, respectively, between the respective two signal connection terminals; and
vertical patterns being formed in two vertical sides, respectively, between the respective two signal connection terminals,
wherein the equipotential forming electrode is formed in a single closed-loop and when predetermined signals are applied to the signal connection terminals, an equipotential is formed between the facing horizontal patterns or between the facing vertical patterns.

11. A method of manufacturing a touch panel for a touch screen, comprising:
coating a transparent conductive film on a transparent substrate; and
forming a closed-loop electrode for forming an equipotential before or after the transparent conductive film is coated on the transparent substrate,
wherein the closed-loop electrode is formed to overlap the transparent conductive film along an edge of an equipotential forming region of the transparent substrate.

12. The method of claim 11, wherein the closed-loop electrode is formed using any one of a printing, a deposition, an inkjet printing, and a Podell.

13. A touch panel for a touch screen, comprising:
a transparent conductive film and an equipotential forming electrode on a transparent substrate,
wherein the equipotential forming electrode comprises a closed-loop electrode in which a resistance value for each unit length changes with respect to the horizontal direction or the vertical direction between a plurality of signal connection terminals.

14. The touch panel of claim 13, wherein the closed-loop electrode is formed before or after the transparent conductive film is coated on the transparent substrate, and is formed to overlap the transparent conductive film along an edge of an equipotential forming region of the transparent substrate.

15. The touch panel of claim 13, wherein the resistance value is changed by changing a number of patterns for each unit length of the closed-loop with respect to the horizontal direction or the vertical direction between the signal connection terminals.

16. The touch panel of claim 13, wherein the resistance value is changed by changing a material of the closed-loop electrode with respect to the horizontal direction or the vertical direction between the signal connection terminals.

17. The touch panel of claim 13, wherein the resistance value is changed by changing a line width or a thickness of the closed-loop electrode with respect to the horizontal direction or the vertical direction between the signal connection terminals.

18. The touch panel of claim 13, wherein the closed-loop electrode is patterned into at least one of a linear pattern, a square-zigzagged pattern, a triangular saw pattern, and a wave pattern between the signal connection terminals.

19. The touch panel of claim 13, further comprising:
an auxiliary electrode being spaced apart from the closed-loop electrode by a predetermined distance along the closed-loop electrode.

20. The touch panel of claim 19, wherein the auxiliary electrode comprises:
a first electrode being separated from a pattern of the closed-loop electrode in the horizontal direction or the vertical direction between the signal connection terminals.

21. The touch panel of claim 20, wherein the auxiliary electrode further comprises:
a second electrode being connected to at least one point of the pattern of the closed-loop electrode in the horizontal direction or the vertical direction between the signal connection terminals.

22. The touch panel of claim 21, wherein the second electrode is connected to a horizontal central point of the closed-loop electrode or a vertical central point thereof.

23. The touch panel of claim 13, wherein the signal connection terminals are connected to a pattern of the closed-loop electrode using the same material, or are separated from the pattern of the closed-loop electrode.

24. The touch panel of claim 13, wherein the signal connection terminals comprise four signal access terminals that are located in corners, respectively.

25. A method of manufacturing a touch panel for a touch screen, comprising:
coating a transparent conductive film on a transparent substrate; and
forming a closed-loop electrode for forming an equipotential in which a resistance value for each unit length changes with respect to the horizontal direction or the vertical direction between a plurality of signal connection terminals.
